(19) United States
(12) Patent Application Publication
(10) Pub. No.: US 2026/0141317 A1
(43) Pub. Date: May 21, 2026

(54) Intuitive and Interactive Travel Itinerary Technique

(71) Applicant: Adriana Ferreyr, Palm Beach, FL (US)

(72) Inventor: Adriana Ferreyr, Palm Beach, FL (US)

(21) Appl. No.: 19/390,448

(22) Filed: Nov. 14, 2025

Related U.S. Application Data
(60) Provisional application No. 63/721,494, filed on Nov. 16, 2024.
(60) Provisional application No. 63/721,490, filed on Nov. 16, 2024.

(51) Int. Cl. G06Q 10/02; G06Q 10/1093

(52) U.S. Cl. CPC G06Q 10/025; G06Q 10/021; G06Q 10/1093

(57) ABSTRACT

During operation, a computer system may intuitively and interactively (or dynamically) present a travel option. Notably, the computer system may receive, from an electronic device, information specifying a desired travel itinerary. In response, the computer system may determine the travel option based at least in part on the information. Then, the computer system may provide, addressed to the electronic device, second information specifying the travel option, where the travel option is configured for display in a calendar format. In some embodiments, the travel option includes an associated total cost. Note that the travel option may be based at least in part on a predefined user preference, such as a budget or preferred travel time.

### CROSS REFERENCE TO RELATED APPLICATIONS

This application claims priority under 35 U.S.C. 119(e) to: U.S. Provisional Application Ser. No. 63/721,494, entitled “Specification_Interaction System Between Travel Agent and Personal Stylist and Related Methods,” by Adriana Ferreyr, et al., filed on Nov. 16, 2024; and U.S. Provisional Application Ser. No. 63/721,490, entitled “AI Travel Itinerary System and Related Methods,” by Adriana Ferreyr, et al., filed on Nov. 16, 2024, the contents of both of which are herein incorporated by reference.

### FIELD

The disclosed embodiments related to techniques for intuitive and interactive presentation of a travel itinerary.

### BACKGROUND

With the advent of digital technologies, the travel industry has undergone a significant transformation, which has made planning and booking trips more accessible and convenient for consumers. Notably, traditional travel agencies have been largely replaced by online platforms that offer a wide range of services, from flight and hotel bookings to car rentals and activity reservations. However, despite these advancements, travelers often face challenges in organizing their itineraries efficiently. The process of coordinating flights, accommodations, and activities can be time-consuming and complicated, especially when trying to adhere to a specific budget or personal preferences.

Moreover, in recent years, artificial network networks (which is sometimes referred to as ‘artificial intelligence’ or AI) has emerged as a powerful tool in various industries, including travel, where it is often used to enhance customer experiences by providing personalized recommendations and streamlined services. AI-powered travel agents have the potential to revolutionize the way people plan their trips by offering tailored itineraries that consider individual preferences, budgets, and schedules. However, in spite of these innovations, existing approaches to planning travel itineraries and activities remain time-consuming, cumbersome and complicated, which is frustrating to consumers.

### SUMMARY

In a first group of embodiments, a computer system that intuitively and interactively presents a travel option is described. This computer system includes: an interface circuit that communicates with an electronic device, a processor that executes program instructions, and memory that stores the program instructions. When the processor executes the program instructions, the computer system performs operations. Notably, during operation, the computer system receives, using the interface circuit and from the electronic device, information specifying a desired travel itinerary. In response, the computer system determines the travel option based at least in part on the information. Then, the computer system provides, using the interface circuit and addressed to the electronic device, second information specifying the travel option, where the travel option is configured for display in a calendar format. In some embodiments, the travel option includes an associated total cost. Note that the travel option may be based at least in part on a predefined user preference, such as a budget or preferred travel time.

Moreover, the computer system may receive, using the interface circuit and from the electronic device, an update to the travel itinerary. For example, the update may include changing one or more of: a departure time, an arrival time, a number of layovers, a total travel time, one or more non-travel activities during the travel option, and/or a cost of the travel itinerary. This update may be associated with or may correspond to a change in the travel option displayed in the calendar format. For example, a user may provide the update by clicking on (or activating) a display icon and dragging or moving the icon or an edge associated with the icon to a different timestamp in the calendar format. (Thus, the user may interact with the calendar to provide the update.) Next, in response to receiving the update, the computer system may provide, using the interface circuit and addressed to the electronic device, third information specifying a second travel option, where the second travel option is configured for display in the calendar format. In some embodiments, the computer system determines the second travel option based at least in part on the update to the travel itinerary. Note that the second travel option may include an updated cost relative to the travel option.

Furthermore, the computer system may receive, using the interface circuit and from the electronic device, acceptance of at least a portion of the travel option (e.g., when the user clicks on or activates an icon in a user interface). When the acceptance of at least the portion of the travel option is received, the computer system may purchase (or book) at least the portion of the travel option on behalf of a traveler. Then, the computer system may provide, using the interface circuit and addressed to the electronic device, a confirmation. (Alternatively, in response to receiving the acceptance, the computer system may provide a link or redirect the user to a web page or a website or an Application Programming Interface or API of a service provider, so the user can purchase or book at least the portion of the travel option.)

In some embodiments, when the purchase uses financial information corresponding to a financial instrument (such as a credit card) of a traveler, the computer system may first request and then receive authorization, from a user of the electronic device, to make the purchase using the financial information.

Additional, the travel option may be determined using a pretrained neural network, such as a large language model (LLM). For example, the pretrained neural network may include an AI itinerary planner.

Note that the travel option may include: flight information, a restaurant, a lodging or accommodation, or an event.

Another embodiment provides a user interface for display on the electronic device, where the user interface facilitates performing at least some of the aforementioned operations in one or more of the preceding embodiments.

Another embodiment provides the electronic device.

Another embodiment provides a computer-readable storage medium with program instructions for use with the computer system or the electronic device. When executed by the computer system or the electronic device, the program instructions cause the computer system or the electronic device to perform at least some of the aforementioned operations in one or more of the preceding embodiments.

Another embodiment provides the method, which may include at least some of the aforementioned operations in one or more of the preceding embodiments.

In a second group of embodiments, a computer system that provides recommended packing instructions is described. This computer system includes: an interface circuit that communicates with an electronic device, a processor that executes program instructions, and memory that stores the program instructions. When the processor executes the program instructions, the computer system performs operations. Notably, during operation, the computer system receives, using the interface circuit and from the electronic device, information specifying a travel itinerary. In response, the computer system provides, using the interface circuit and addressed to the electronic device, the recommended packing instructions based at least in part on the travel itinerary, where the recommended packing instructions include a wardrobe of clothing. For example, the recommended packing instructions may be provided using email, a text message, or a push notification.

Note that the recommended packing instructions may be based at least in part on a weather forecast for one or more destinations in the travel itinerary.

Moreover, the recommended packing instructions may be based in part on a predefined preference. For example, the predefined preference may include: an amount of luggage a traveler wants to bring on the travel itinerary; a fashion style of the traveler; one or more reservations or travel accommodations of the traveler; a planned activity during the travel itinerary; items in a wardrobe of the traveler that are not in laundry or that are clean; or a travel purpose.

Furthermore, the recommended packing instructions may include instructions to purchase one or more items that are not included in a wardrobe of the traveler. Alternatively, when the one or more items are not included in the wardrobe of the traveler, the computer system may automatically purchase the one or more items for the traveler.

Additionally, the recommended packing instructions may be based at least in part on a predefined geometric size of luggage of the traveler.

Note that the recommended packing instructions may include one or more suggested outfits for the traveler. The computer system may allow the traveler to virtually try on a suggested outfit, e.g., using a digital avatar.

In some embodiments, the recommended packing instructions are provided by a pretrained neural network, such as a large language model (LLM).

Another embodiment provides the electronic device.

Another embodiment provides a computer-readable storage medium with program instructions for use with the computer system or the electronic device. When executed by the computer system or the electronic device, the program instructions cause the computer system or the electronic device to perform at least some of the aforementioned operations in one or more of the preceding embodiments.

Another embodiment provides the method, which may include at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a block diagram illustrating an example of a communication with a computer system that evaluates a potential gift in accordance with an embodiment of the present disclosure.

FIG. 2 is a flow diagram illustrating an example of a method for presenting a travel option using the computer system of FIG. 1 in accordance with an embodiment of the present disclosure.

FIG. 3 is a drawing illustrating an example of communication among components in the computer system in FIG. 1 in accordance with an embodiment of the present disclosure.

FIG. 4 is a drawing illustrating an example of a user interface in accordance with an embodiment of the present disclosure.

FIG. 5 is a flow diagram illustrating an example of a method for providing recommended packing instructions using the computer system of FIG. 1 in accordance with an embodiment of the present disclosure.

FIG. 6 is a drawing illustrating an example of communication among components in the computer system in FIG. 1 in accordance with an embodiment of the present disclosure.

FIG. 7 is a drawing illustrating an example of a user interface in accordance with an embodiment of the present disclosure.

FIG. 8 is a block diagram illustrating an example of an electronic device of FIG. 1 in accordance with an embodiment of the present disclosure.

FIG. 9 is a block diagram illustrating an example of a data structure for use with the electronic device of FIG. 8 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system (which may include one or more computers) that intuitively and interactively (or dynamically) presents a travel option is described. During operation, the computer system may receive, from an electronic device, information specifying a desired travel itinerary. In response, the computer system may determine the travel option based at least in part on the information. Then, the computer system may provide, addressed to the electronic device, second information specifying the travel option, where the travel option is configured for display in a calendar format. In some embodiments, the travel option includes an associated total cost. Note that the travel option may be based at least in part on a predefined user preference, such as a budget or preferred travel time.

Moreover, the computer system may receive, from the electronic device, an update to the travel itinerary. For example, the update may include changing one or more of: a departure time, an arrival time, a number of layovers, a total travel time, one or more non-travel activities during the travel option, and/or a cost of the travel itinerary. This update may be associated with or may correspond to changes in the travel option displayed in the calendar format. For example, a user may provide the update by clicking on (or activating) a display icon and dragging or moving the icon or an edge associated with the icon to a different timestamp in the calendar format. (Thus, the user may interact with the calendar to provide the update.) Next, in response to receiving the update, the computer system may provide, addressed to the electronic device, third information specifying a second travel option, where the second travel option is configured for display in a calendar format. In some embodiments, the computer system determines the second travel option based at least in part on the update to the travel itinerary. Note that the second travel option may include an updated cost relative to the travel option.

By presenting the travel option in the calendar format, these presentation techniques may allow a user to view and intuitively and interactively adjust the desired travel itinerary and, thus, the presented travel option. These capabilities may allow the user to efficiently adapt the travel option(s) in a simple manner. Consequently, the presentation techniques may allow the user to dynamically navigate through a set of travel options in a less time-consuming and an easy to understand manner, while conforming to constraints, such as a budget or a personal preference. In the process, the presentation techniques may improve the function of the computer system, such as by reducing a number processor cycles, memory consumption and/or network bandwidth. Therefore, the presentation techniques may improve a user experiences when planning and/or purchasing the travel option.

In a second group of embodiments, a computer system (which may include one or more computers) that provides recommended packing instructions is described. During operation, the computer system may receive, from an electronic device, information specifying a travel itinerary. In response, the computer system may provide, addressed to the electronic device, the recommended packing instructions based at least in part on the travel itinerary, where the recommended packing instructions include a wardrobe of clothing.

By providing the recommended packing instructions, these travel techniques may improve the user experience when traveling. For example, the travel techniques may reduce user stress when preparing for a trip and may help ensure that the user's luggage is packed in a time efficient and accurate manner, such as based at least in part on a weather forecast at one or more locations in the travel itinerary. Thus, the travel techniques may improve the satisfaction of the user and may encourage travel.

In the discussion that follows, an individual or a user (such as a traveler) may be a person. Also, or instead, the travel and presentation techniques may be used by any type of organization, such as a business (which should be understood to include for-profit corporations), non-profit corporations, groups (or cohorts) of individuals, sole proprietorships, government agencies, partnerships, etc.

Moreover, in the discussion that follows, electronic devices and/or components in a system (such as the computer system) may communicate using a wide variety of communication protocols. For example, the communication may involve wired or wireless communication. Notably, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, the communication protocols may include: an Institute of Electrical and Electronics Engineers (IEEE) 802.11 standard (which is sometimes referred to as ‘Wi-Fi®,’ from the Wi-Fi Alliance of Austin, Texas), Bluetooth® (from the Bluetooth Special Interest Group of Kirkland, Washington), another type of wireless interface (such as another wireless-local-area-network interface), a cellular-telephone communication protocol (e.g., a 3G/4G/5G communication protocol, such as UMTS, LTE), other present or future developed advanced cellular communication protocol, Citizens Broadband Radio Service (CBRS), and/or another type of wireless interface or wireless communication protocol. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. In the discussion that follows, Ethernet and Wi-Fi are used as illustrative examples.

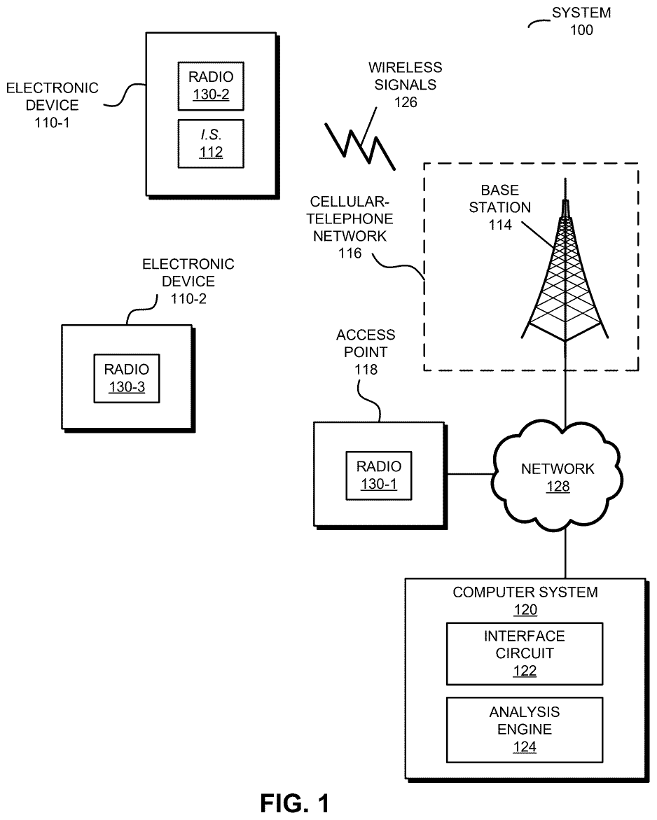

Communication among electronic devices is shown in FIG. 1, which presents a block diagram illustrating a system 100 that presents a travel itinerary. Notably, system 100 includes one or more electronic devices 110 (such as portable electronic devices, e.g., cellular telephones, cameras, etc.), which may include an optional imaging sensor (I.S.) 112 (such as a CMOS image sensor, a CCD, a camera, etc.), optional base station 114 in cellular-telephone network 116, an optional access point 118 and/or a computer system 120 (such as a server), which are sometimes collectively referred to as ‘components’in system 100. Moreover, computer system 120 may include: an interface circuit (or module) 122, and an analysis engine (or module) 124.

Note that components in system 100 may communicate with each other via cellular-telephone network 116 and/or a network 128 (such as the Internet and/or a wireless local area network or WLAN). For example, computer system 120 may receive information (such as a desired travel itinerary or a travel option) from electronic devices 110, and may analyze the information, e.g., using program instructions or one or more machine-learning models (such as an LLM, e.g., a version of ChatGPT from Open AI of San Francisco, California). In general, at least portions of the one or more machine-learning models may be executed by one or more of electronic devices 110, computer system 120 or both.

In addition, electronic device 110-1 may provide, via cellular-telephone network 116 and/or network 128, instructions for a user interface that displays a travel option corresponding to the desired travel itinerary in a calendar format.

In embodiments where the communication involves wireless communication via a WLAN, the wireless communication includes: transmitting advertising frames on wireless channels, detecting another component in system 100 by scanning wireless channels, establishing connections (for example, by transmitting association requests, data/management frames, etc.), optionally configuring security options (e.g., Internet Protocol Security), and/or transmitting and receiving packets or frames via the connection (which may include information that specifies the potential gift, the feedback about the suitability of the potential gift, etc.). Moreover, in embodiments where the communication involves wireless communication via cellular-telephone network 116 and/or the WLAN, the wireless communication may include: establishing connections, and/or transmitting and receiving packets (which may include information that specifies the one or more machine-learning models, the measurement results, etc.).

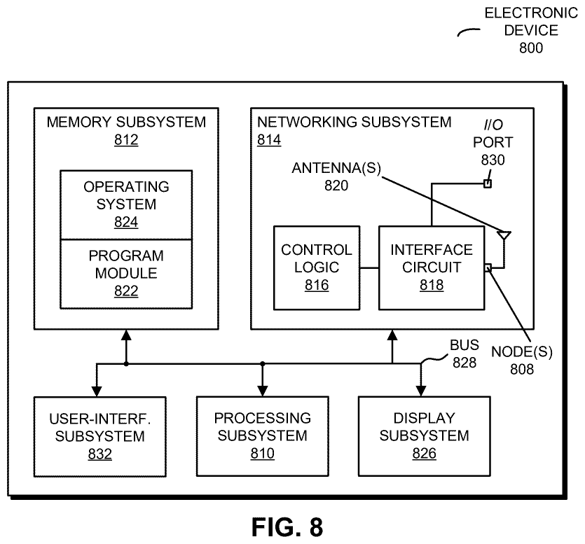

As described further below with reference to FIG. 8, electronic devices 110, optional base station 114, optional access point 118 and/or computer system 120 may include subsystems, such as a networking subsystem, a memory subsystem and a processor subsystem. In addition, electronic devices 110, optional base station 114, optional access point 118 and/or computer system 120 may include radios 130 in the networking subsystems. More generally, the components can include (or can be included within) any electronic devices with the networking subsystems that enable these components to communicate with each other.

Moreover, as can be seen in FIG. 1, wireless signals 126 (represented by jagged lines) are transmitted by radios 128 in the components. For example, radio 130-1 in optional access point 118 may transmit information (such as frames or packets) using wireless signals 126. These wireless signals may be received by radios 128 in one or more of the other components, such as by electronic device 110-1. This may allow computer system 120 and electronic device 110-1 to communicate information with each other.

In the described embodiments, processing a packet or frame in a component may include: receiving the wireless signals with the packet or frame; decoding/extracting the packet or frame from the received wireless signals to acquire the packet or frame; and processing the packet or frame to determine information contained in the packet or frame (such as the one or more machine-learning models, a desired travel itinerary, a travel option, etc.).

Note that the communication between at least any two of the components in system 100 may be characterized by one or more of a variety of performance metrics, such as: a received signal strength indication (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

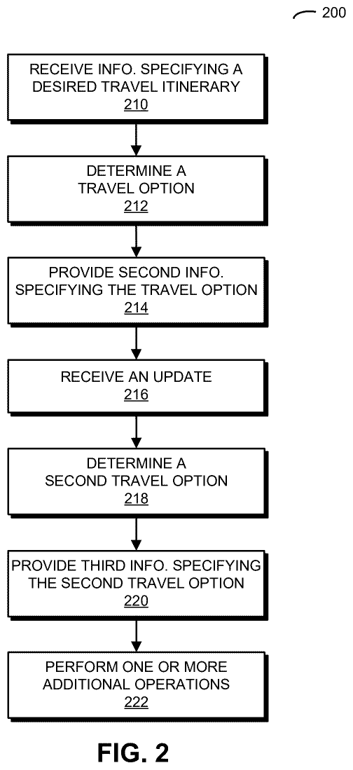

As discussed previously, it can be difficult for a user to navigate through a complicated set of travel options while planning a trip. As described further below with reference to FIGS. 2-4, in order to address this problem, computer system 120 may be used to interactively and intuitively present one or more travel options in a calendar format.

Notably, a user (who is sometimes referred to as a ‘prospective traveler’ or ‘traveler’) of an electronic device (such as electronic device 110-1) may provide information specifying a desired travel itinerary. This information may be received by an interface circuit 122 in computer system 120. Then, an analysis module 124 in computer system 120 may compute or determine the one or more travel options (such as a travel option) based at least in part on the information and/or a predefined user preference, such as a budget or preferred travel time. For example, the one or more travel options may be determined using a pretrained neural network, such as a LLM and/or an artificial intelligence (AI) itinerary planner. Note that the travel option may include: flight information, a restaurant, a lodging or accommodation, or an event associated with the travel itinerary.

In some embodiments, the determination may be computed using Dijkstra's algorithm, a genetic algorithm, a greedy algorithm, a backtracking algorithm, a Simplex technique, a dynamic pricing technique, a gradient-guided genetic algorithm, an evolutionary algorithm, a value sensitive recommendation technique (which may respect personal preferences, such as romantic trip, while meeting a budgetary constraint), a multi objective optimization technique, a pretrained neural network, and/or a machine-learning technique. For example, the hybrid recommendation technique may generate personalized, end-to-end travel itineraries or travel options, which may include: spa services, airline segments, restaurant reservations, recreational activities, guided tours, transportation modes, lodging options, and/or other schedulable events. Moreover, the pretrained neural network may be trained to learn latent user-preference representations from heterogeneous input data, including: historical user interactions, stated preferences, contextual constraints (e.g., temporal, geographic, or budgetary limitations), and domain-specific metadata. Note that the learned representations may be input to a genetic algorithm that performs a combinatorial search over multiple feasible itineraries. Alternatively or additionally, the itinerary-generation process may be formalized as a multi-objective optimization problem in which the objectives may include: maximizing preference alignment, maintaining temporal and logistical feasibility, minimizing cost, satisfying user-defined constraints, and/or optimizing overall itinerary coherence. In these embodiments a genetic algorithm may be used to perform iterative selection, crossover, and/or mutation operations on candidate itinerary solutions to converge toward high-quality recommendations. In some embodiments, the recommendations may include ranked recommendations.

Then, computer system 120 may provide, using interface circuit 122 and addressed to electronic device 110-1, second information specifying the travel option, where the travel option is configured for display in a calendar format. In some embodiments, the travel option includes an associated total cost. After receiving the second information, electronic device 110-1 may present or display the travel option in the calendar format, e.g., in a user interface.

The user may interact with this calendar to adapt or modify the travel option or the travel itinerary. For example, the user may activate or click on an icon in the user interface, and may draft and drop (or release) the icon (or an edge of the icon) at a different timestamp (or date and/or time) in the calendar. This may specify an update to the travel option or, more generally, the travel itinerary. For example, the update may include changing one or more of: a departure time, an arrival time, a number of layovers, a total travel time, one or more non-travel activities during the travel option, and/or a cost of the travel itinerary. Moreover, electronic device 110-1 may provide the update to computer system 120.

After receiving the update using interface circuit 122, analysis module 124 may compute or determine a second travel option based at least in part on the information, the update and/or a predefined user preference. Note that the second travel option may include an updated cost relative to the travel option. Next, interface circuit 122 may provide, addressed to electronic device 110-1, third information specifying the second travel option, where the second travel option is configured for display in the calendar format. After receiving the third information, electronic device 110-1 may present or display the second travel option in the calendar format, e.g., in a user interface.

The user may accept at least a portion of the travel option or the second travel option, e.g., by activating or clicking on an icon in the user interface. In response, electronic device 110-1 may provide the acceptance of at least the portion of the travel option or the second travel option to computer system 120. For example, a user may accept all the determined travel options or may only accept a portion of the travel options (such as air travel, dinner reservations or a spa treatment. After receiving the acceptance using interface circuit 122, analysis module 124 may purchase (or book) at least the portion of the travel option or the second travel option on behalf of the user. Then, interface circuit 122 may provide, addressed to electronic device 110-1, a confirmation.

Note that, when the purchase uses financial information corresponding to a financial instrument (such as a credit card) of the user, interface circuit 122 may first request and then receive authorization, from the user of electronic device 110-1, to make the purchase using the financial information.

Alternatively, in response to receiving the acceptance, interface circuit 122 may provide, addressed to electronic device 110-1, a link or may redirect the user to a web page or a website or an Application Programming Interface (API) of a service provider, so the user can purchase or book at least the portion of the travel option or the second travel option.

In these ways, computer system 120 (such as software or a software application executed in an environment, such as an operating system, of computer system 120) may improve the ability of the user to intuitively understand and interactively modify the one or more travel options and/or the travel itinerary. These capabilities may enhance the user experience when using electronic device 110-1 and/or computer system 120, and more generally when planning a trip.

In some embodiments, analysis module 124 may determine one or more travel options using a pretrained machine-learning model (such as the LLM), such as using one or more graphics processing units or GPUs.

Note that the program instructions in analysis module 124 may include: a standalone software application or a portion of another software application that is resident on and that executes on computer system 120 and/or electronic device 110-1 (such as a software application that is provided by computer system 120 and/or electronic device 110-1, or that is installed on and that executes on computer system 120 and/or electronic device 110-1). Alternatively or additionally, at least a portion of the software application executing on computer system 120 and/or electronic device 110-1 may be an application tool that is embedded in the web page, and that executes in a virtual environment of a web browser. Thus, the application tool may be provided to a user of computer system 120 and/or electronic device 110-1 via a client-server architecture.

Although we describe the network environment shown in FIG. 1 as an example, in alternative embodiments, different numbers or types of electronic devices may be present. For example, some embodiments comprise more or fewer components. As another example, in another embodiment, different components are transmitting and/or receiving packets or frames.

We now describe embodiments of the presentation techniques. FIG. 2 presents a flow diagram illustrating an example of a method 200 for presenting a travel option, which may be performed by a computer system (such as computer system 120 in FIG. 1). During operation, the computer system may receive, from ab electronic device, information specifying a desired travel itinerary (operation 210). In response, the computer system may determine the travel option (operation 212) based at least in part on the information. Note that the travel option may include: flight information, a restaurant, a lodging or accommodation, or an event. Moreover, the travel option may be determined using a pretrained neural network, such as an LLM. For example, the pretrained neural network may include an AI itinerary planner.

Then, the computer system may provide, addressed to the electronic device, second information (operation 214) specifying the travel option, where the travel option is configured for display in a calendar format. In some embodiments, the travel option includes an associated total cost. Note that the travel option may be based at least in part on a predefined user preference, such as a budget or preferred travel time.

Moreover, the computer system may receive, from the electronic device, an update (operation 216) to the travel option and/or the travel itinerary. For example, the update may include changing one or more of: a departure time, an arrival time, a number of layovers, a total travel time, one or more non-travel activities during the travel option, and/or a cost of the travel itinerary. This update may be associated with or may correspond to a change in the travel option displayed in the calendar format. In some embodiments, a user may provide the update by clicking on (or activating) a display icon and dragging or moving the icon or an edge associated with the icon to a different timestamp in the calendar format. (Thus, the user may interact with the calendar to provide the update.) Next, in response to receiving the update, the computer system may determine a second travel option (operation 218) based at least in part on the update, where the second travel option is configured for display in the calendar format. Furthermore, the computer system may provide, addressed to the electronic device, third information specifying the second travel option (operation 220). Note that the second travel option may include an updated cost relative to the travel option.

In some embodiments, the computer system may optionally perform one or more operations (operations 222). For example, the computer system may receive, from the electronic device, acceptance of at least a portion of the travel option (e.g., when the user clicks on or activates an icon in a user interface). When the acceptance of at least the portion of the travel option is received, the computer system may purchase (or book) at least the portion of the travel option on behalf of a traveler. Then, the computer system may provide, addressed to the electronic device, a confirmation. (Alternatively, in response to receiving the acceptance, the computer system may provide a link or redirect the user to a web page or a website or an API of a service provider, so the user can purchase or book at least the portion of the travel option.)

In some embodiments, when the purchase uses financial information corresponding to a financial instrument (such as a credit card) of a traveler, the computer system may first request and then receive authorization, from a user of the electronic device, to make the purchase using the financial information.

In some embodiments of method 200, there may be additional or fewer operations. Moreover, the order of the operations may be changed, and/or two or more operations may be combined into a single operation.

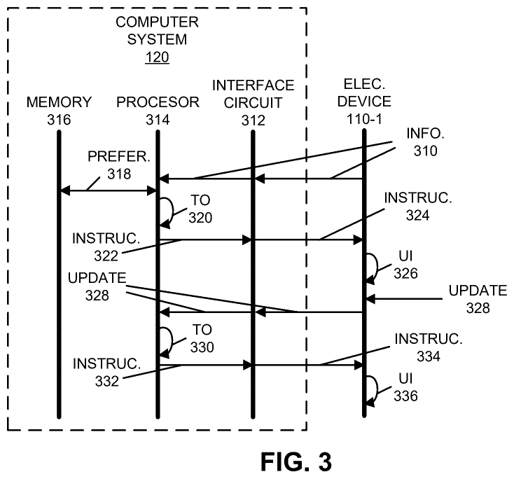

Embodiments of the presentation techniques are further illustrated in FIG. 3, which presents a drawing illustrating an example of communication among components in computer system 120. Notably, electronic device 110-1 may provide (e.g., in one or more packets or frames) information 310 specifying a desired travel itinerary.

After receiving information 310, an interface circuit 312 in computer system 120 may provide information 310 to a processor 314 in computer system 120. Then, processor 314 may access, e.g., in memory 316 in computer system 120, one or more preferences 318 (such as one or more predefined preferences of a user of electronic device 110-1). Moreover, using information 310 and/or the one or more preferences 318, processor 314 may determine a travel option (TO) 320.

Next, processor 314 may instruct 322 interface circuit 312 to provide, addressed to electronic device 110-1, instructions 324 for a user interface (UI) 326 that includes travel option 320 in a calendar format. After receiving instructions 324, electronic device 110-1 may display user interface 326.

Subsequently, electronic device 110-1 may receive update 328 to travel option 320 and/or the travel itinerary. Then, electronic device 110-1 may provide, addressed to computer system 120, update 328.

After receiving update 328, interface circuit 312 may provide update 328 to processor 314. Moreover, using information 310, the one or more preferences 318 and/or update 328, processor 314 may determine a travel option 330.

Next, processor 314 may instruct 332 interface circuit 312 to provide, addressed to electronic device 110-1, instructions 334 for a user interface 336 that includes travel option 330 in a calendar format. After receiving instructions 334, electronic device 110-1 may display user interface 336.

While FIG. 3 illustrates communication between components using unidirectional or bidirectional communication with lines having single arrows or double arrows, in general the communication in a given operation in this figure may involve unidirectional or bidirectional communication. Moreover, while operations are presented sequentially in FIG. 3, in general at least some of the operations may be performed concurrently or in parallel.

We now further describe the presentation techniques. These presentation techniques may be used to display one or more suggested travel options in an interactive calendar. For example, an AI travel itinerary planner may display one or more suggested travel options in the interactive calendar. This suggested travel itinerary may include various components, such as: flight information, dining suggestions, lodging suggestions, and/or activity suggestions. For example, the travel itinerary may include what city the user wants to travel to, what dates are planned for the trip, and/or the budget. These recommendations may be presented as events in the interactive calendar. The AI travel itinerary planner may suggest the travel itinerary based at least in part on a budget of a user and preferences of the user, thereby tailoring one or more travel options to the user's needs. The interactive calendar may serve to provide a visual representation of the one or more travel options, allowing the user to view and interact with the planned events.

The events may be displayed as scheduled in the calendar, and the user may have the ability to modify the suggested one or more travel options by moving the events around using a mouse. This capability may enable user customization of the one or more travel options, allowing adjustment(s) to the travel schedule as needed. The AI travel itinerary planner may recommend entire trip itineraries, organize travel plans and/or show travel details to enhance the user's travel experience. Thus, the interactive calendar may function as a tool to gather information (such as a desired travel itinerary) and provide travel planning, offering a comprehensive view of the one or more travel options.

In the context of interactive display of a trip budget, the presentation techniques may be used to present a trip budget amount prominently on top of the interactive calendar. This display may serve to inform the user of the budget status and provide real-time budget updates. The interactive trip budget display may be associated with the displayed budget, which may be adjusted to manage travel expenses effectively. The budget may be prominently positioned in or proximate to the calendar to ensure visibility and may be dynamically updated to reflect any changes in the one or more travel options. This dynamic adjustment may be facilitated by the interactive nature of the calendar, which may allow users to modify the one or more travel options, thereby impacting the displayed budget. The integration of the displayed budget with the interactive calendar may enable a seamless user experience, where budgetary considerations are continuously aligned with modifications to the one or more travel options. The presentation techniques may be designed to ensure that any changes made to the one or more travel options, such as adjustments in travel dates or selection of different activities, are immediately reflected in the displayed budget. This integration may be achieved using an analysis technique that calculates the cost implications of each itinerary modification and updates the displayed budget. Thus, the interactive trip budget display may play a role in providing users with a comprehensive overview of their travel expenses, allowing for informed decision-making and efficient budget management.

The interactive displayed trip budget may be updated to reflect the cost of currently selected itinerary components when a user modifies the suggested one or more travel options. This may involve the interactive displayed trip budget, which may serve to inform the user of the budget status and provide real-time budget updates. The interactive displayed trip budget may be associated with the budget adjustment, which may manage travel expenses.

The process may begin with the user interacting with the AI travel itinerary planner, which may suggest one or more travel options based at least in part on the user's desired or target budget and/or one or more other preferences. The AI travel itinerary planner may display one or more suggested travel options in an interactive calendar, providing a visual representation of the one or more travel options and tailoring it to the user's needs. As the user modifies the one or more suggested travel options, the interactive displayed trip budget may dynamically update the trip budget amount to reflect the cost of the selected one or more travel options. This update may be prominently displayed on top of the interactive calendar, ensuring that the user is continuously informed of the budget status.

The interactive displayed trip budget may be designed to manage travel expenses effectively, allowing the user to make informed decisions about their travel plans. The integration of the interactive displayed trip budget with the AI travel itinerary planner may facilitate a seamless user experience, enabling the user to customize the one or more travel options, while maintaining awareness of their budget constraints. This process may be further enhanced by the ability of the AI travel itinerary planner to integrate with a service booking and payment system via an API, allowing for the booking and payment of travel services on behalf of the user, such as: flights, hotels, and/or activities (such as a restaurant or a spa treatment). The overall system may provide a comprehensive solution for planning and booking a desired travel itinerary, offering users the flexibility to adjust their plans while keeping track of their budget.

For example, the process may involve updating the trip budget amount when the user adjusts the trip duration by scrolling the interactive calendar. This action may be facilitated by the interactive displayed trip budget, which may dynamically reflect changes in the budget as the user interacts with the calendar. The interactive displayed trip budget may serve to inform the user of the budget status and provide real-time budget updates, ensuring that any modifications to the trip itinerary and/or the one or more travel options are immediately accounted for in the budget. The budget adjustment may be displayed prominently on top of the interactive calendar, allowing the user to manage travel expenses effectively.

The presentation techniques may incorporate a mechanism in which a scrolling action in the calendar, potentially executed through a mouse or similar human or user input device, may lead to a recalibration of the trip duration, thereby influencing the overall budget. This interaction may be designed to offer a seamless and intuitive user experience, where the financial implications of changes or updates to the one or more travel options are transparently communicated. The integration of these functionalities may be achieved through a user interface that aligns with the user's preferences and budgetary constraints, as suggested by the AI travel itinerary planner. The AI travel planner may use the user's input to tailor the itinerary, ensuring that the travel plans are both personalized and financially viable. This approach may enhance the user's ability to customize their travel experience, while maintaining control over the budget.

In some embodiments, the presentation techniques may interact with a service booking and payment system via an API. This capability may enable the AI travel itinerary planner to book and pay for travel services on behalf of the user. This integration may allow for seamless communication between the AI travel itinerary planner and a service provider's computer system, potentially streamlining the booking process. These components may serve as a bridge, allowing the AI travel itinerary planner to access and manage reservations through the API. This integration may facilitate automated booking and payment, thereby enhancing user convenience.

Note that the presentation techniques may support multiple languages and currencies, catering to a diverse user base. Moreover, the presentation techniques may handle exceptions and errors gracefully, ensuring stability and reliability. The presentation techniques may support various levels of access and permissions, ensuring that only authorized users can perform certain actions. Communication in the presentation techniques may be secure to protect user privacy. The presentation techniques may support various types of travel itineraries, including single and multi-destination trips.

Alternatively or additionally, the presentation techniques may incorporate a user booking interface that allows the user to purchase travel services by being directed to the web page(s) and/or website(s) of one or more travel service providers through a link. This user booking interface may offer users the flexibility to explore service options directly on the service provider's web page(s) and/or website(s), potentially providing more detailed information and options. In some embodiments, the user may have the option to purchase one or more travel options by pressing a buy now button in or proximate to the calendar in the user interface, which may facilitate a quicker transaction process by allowing users to make immediate purchases without navigating away from the user interface.

Furthermore, the user booking interface may also allow the user to ask the AI travel itinerary planner to complete a specific reservation for a specific time displayed on the interactive calendar by clicking a button. This feature may provide users with the convenience of delegating the reservation task to the AI travel itinerary planner, potentially saving time and effort. The integration of this functionality may enhance the user experience by providing multiple avenues for booking and purchasing the one or more travel options, thereby catering to diverse user preferences and needs.

In some embodiments, an interactive displayed trip budget may provide real-time budget updates and may prominently display the trip budget on the calendar. This capability may be associated with the action of updating the trip budget amount to reflect the cost of one or more currently selected trip options. The displayed trip budget may inform the user of the budget status and may provide real-time budget updates, which may be used to manage travel expenses. The budget may be displayed and adjusted based at least in part on interactions with the user, such as modifying one or more travel options or adjusting the trip itinerary (such as the trip duration). The interactive displayed trip budget may be integrated with the AI travel itinerary planner, which may suggest one or more travel options based at least in part on the user's budget and preferences. The AI travel itinerary planner may display the one or more suggested travel options in an interactive calendar, providing a visual representation tailored to the user's needs.

The integration may allow for seamless updates to the displayed budget as the user interacts with the one or more travel options. The computer system may also facilitate booking and payment for travel services through integration with service booking and payment systems via an API. Moreover, the integration may enhance the functionality of the interactive calendar by ensuring that budget updates are accurate and reflective of actual costs. The user may be able to modify the one or more suggested travel options by moving events around using a mouse, which may enable customization of the one or more travel options. This interaction may directly impact the displayed budget, as changes to the one or more travel options may result in updates to the budget amount. The presentation techniques may provide users with a comprehensive and interactive travel planning experience, allowing for real-time budget management and customization of travel plans.

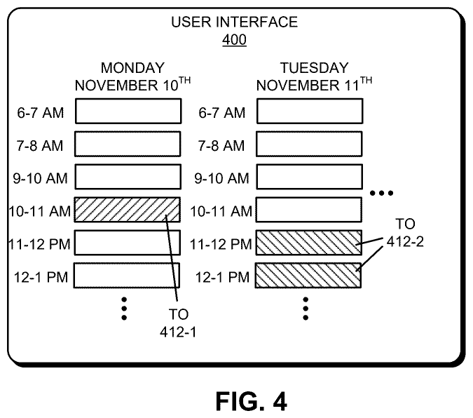

FIG. 4 presents a drawing illustrating an example of a user interface 400 that presents one or more travel options corresponding to a travel itinerary in a calendar format. User interface 400 may include one or more travel options 412. By presenting the one or more travel options 412 in a calendar, a user may be intuitively able to understand the presented information. Moreover, by clicking on or selecting an icon or an edge of an icon corresponding to a given travel option (such as travel option 412-1), the user may be able to modify or update one or more of the one or more travel options 412 using drag and drop functionality.

We now describe embodiments of the travel techniques, which may be used to provide recommended packing instructions. In today's fast-paced world, the travel and fashion industries are increasingly intersecting, driven by the growing demand for personalized experiences. Travelers are not only seeking unique destinations but also personalized services that cater to their individual preferences and styles. This has led to the emergence of innovative solutions that aim to enhance the travel experience by integrating various aspects of a traveler's journey, including their wardrobe choices.

The challenge in this process lies in effectively combining travel itineraries with personal styling to create a seamless experience for users. Traditional techniques of packing and styling for trips often involve manual coordination between travel plans and wardrobe selections, which can be time-consuming and inefficient. The disclosed travel techniques provide convenience and personalization that can intelligently integrate travel data and/or personal styling preferences to provide tailored recommendations. This integration not only enhances the travel experience but also addresses the growing consumer demand for technology-driven solutions that simplify and enrich their lives.

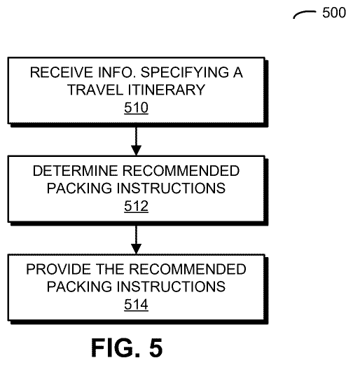

Referring to FIG. 1, as described below with reference to FIGS. 5-7, electronic device 110-1 may provide, addressed to computer system 120, information specifying travel itinerary. After receiving this information, interface circuit 122 may provide the information to analysis module 124. Analysis module 124 may determine recommended packing instructions based at least in part on the travel itinerary, a weather forecast for one or more destinations in the travel itinerary, a predefined geometric size of luggage of the traveler, and/or one or more preferences, where the recommended packing instructions include a wardrobe of clothing. For example, the predefined preference may include: an amount of luggage a traveler wants to bring on the travel itinerary; a fashion style of the traveler; one or more reservations or travel accommodations of the traveler; a planned activity during the travel itinerary; items in a wardrobe of the traveler that are not in laundry or that are clean; or a travel purpose (such as business or leisure). In some embodiments, the recommended packing instructions are determined by analysis module 124 using a pretrained neural network, such as an LLM (e.g., a version of ChatGPT from Open AI of San Francisco, California).

Then, interface circuit 122 may provide, addressed to electronic device 110-1, the recommended packing instructions. For example, the recommended packing instructions may be provided using email, a text message, or a push notification.

In some embodiments, the recommended packing instructions may include instructions to purchase one or more items that are not included in a wardrobe of the traveler. Alternatively, when the one or more items are not included in the wardrobe of the traveler, computer system 120 may automatically purchase the one or more items for the traveler.

Moreover, the recommended packing instructions may include one or more suggested outfits for the traveler. Computer system 120 may allow the traveler to virtually try on a suggested outfit, e.g., using a digital avatar that is provided by interface circuit 122 and addressed to electronic device 110-1.

FIG. 5 presents a flow diagram illustrating an example of a method 500 for providing recommended packing instructions, which may be performed by a computer system (such as computer system 120 in FIG. 1). During operation, the computer system may receive, from an electronic device, information specifying a travel itinerary (operation 510). In response, the computer system may determine the recommended packing instructions (operation 512) based at least in part on the travel itinerary, where the recommended packing instructions include a wardrobe of clothing. In some embodiments, the recommended packing instructions are determined (operation 512) by a pretrained neural network, such as an LLM. Next, the computer system may provide, addressed to the electronic device, the recommended packing instructions (operation 514). For example, the recommended packing instructions may be provided (operation 514) using email, a text message, or a push notification.

Note that the recommended packing instructions may be based at least in part on a weather forecast for one or more destinations in the travel itinerary (such as hot, cold, rainy or dry weather). Moreover, the recommended packing instructions may be based in part on a predefined preference of the traveler. For example, the predefined preference may include: an amount of luggage a traveler wants to bring on the travel itinerary (such as one or two bags); a fashion style of the traveler; one or more reservations or travel accommodations of the traveler; a planned activity during the travel itinerary; items in a wardrobe of the traveler that are not in laundry or that are clean; and/or a travel purpose.

Furthermore, the recommended packing instructions may include instructions to purchase one or more items that are not included in a wardrobe of the traveler. Alternatively, when the one or more items are not included in the wardrobe of the traveler, the computer system may automatically purchase the one or more items for the traveler.

Additionally, the recommended packing instructions may be based at least in part on a predefined geometric size of luggage of the traveler. For example, the luggage may include: a backpack, a handbag, a small roller bag (which may fit in an overhead compartment in an aircraft), or checked luggage (which may be carried in an aircraft hold).

Note that the recommended packing instructions may include one or more suggested outfits for the traveler. The computer system may allow the traveler to virtually try on a suggested outfit, e.g., using a digital avatar.

In some embodiments of method 500, there may be additional or fewer operations. Moreover, the order of the operations may be changed, and/or two or more operations may be combined into a single operation.

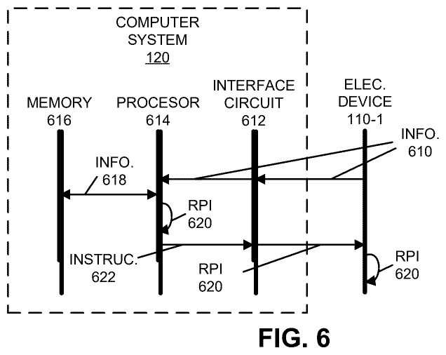

Embodiments of the travel techniques are further illustrated in FIG. 6, which presents a drawing illustrating an example of communication among components in computer system 120. Notably, electronic device 110-1 (associated with a user) may provide (e.g., in one or more packets or frames) information 610 specifying a travel itinerary.

After receiving information 610, an interface circuit 612 in computer system 120 may provide information 610 to a processor 614 in computer system 120. Then, processor 614 may access, in memory 616 in computer system 120, additional information 618, such as: a weather forecast for one or more destinations in the travel itinerary, a predefined preference of the traveler (such as: an amount of luggage a traveler wants to bring on the travel itinerary; a fashion style of the traveler; one or more reservations or travel accommodations of the traveler; a planned activity during the travel itinerary; items in a wardrobe of the traveler that are not in laundry or that are clean; and/or a travel purpose), and/or a predefined geometric size of luggage of the traveler.

Then, processor 614 may determine recommended packing instructions (RPI) 620 based at least in part on information 610 and/or additional information 618, where the recommended packing instructions include a wardrobe of clothing.

Next, processor 614 may instruct 622 interface circuit 612 to provide, addressed to electronic device 110-1, the recommended packing instructions 620. After receiving the recommended packing instructions 620, electronic device 110-1 may display the recommended packing instructions 620.

While FIG. 6 illustrates communication between components using unidirectional or bidirectional communication with lines having single arrows or double arrows, in general the communication in a given operation in this figure may involve unidirectional or bidirectional communication. Moreover, while operations are presented sequentially in FIG. 6, in general at least some of the operations may be performed concurrently or in parallel.

We now further describe the travel techniques. In the travel techniques, an intelligent travel planning system may receive a trip booking request from a user. This request may include personalized user preferences and trip details (such as a travel itinerary). The intelligent travel planning system, such as an AI travel agent, may use this information to initiate a travel planning process. The personalized user preferences may encompass various aspects, such as: travel preferences, accommodation preferences, and/or activity preferences. Moreover, the travel itinerary may include: the destination, duration, and/or details of the trip.

This information may be stored in a user preference data structure, which may securely maintain the data for future reference and seamless data sharing between the intelligent travel planning system and an intelligent personal styling system. Then, the AI travel agent may use this data to recommend one or more travel options for the user's trip, ensuring that the travel plans align with the user's preferences and requirements. This process may facilitate a more personalized and efficient travel planning experience, allowing the user to receive tailored recommendations and suggestions for their upcoming trip. However, in other embodiments of the travel techniques, the user may provide a finalized travel itinerary to the computer system.

Thus, the intelligent travel planning system may schedule a trip based on the personalized user preferences and trip details. This scheduling process may involve the travel AI system, which may use the data received from the user's trip booking request. The computer system may analyze the personalized user preferences, which may include travel, accommodation, and/or activity preferences, as well as trip details such as destination, duration, and details. The travel AI system may then organize these details to plan the user's trip effectively. This process may ensure that the trip aligns with the user's needs and desires, potentially enhancing the overall travel experience. The scheduling of the trip may also involve storing the relevant data in a user preference data structure, which may maintain user data for future reference and facilitate seamless data sharing between the intelligent travel planning system and the intelligent personal styling system. This integration may allow for a cohesive interaction between the travel agent and the personal stylist, enabling the personal stylist to access the necessary information to provide tailored suitcase and outfit recommendations for the user (which are sometimes referred to collectively as ‘packing instructions’).

The user preference data structure may store the personalized user preferences and trip details. This storage process may involve the collection and organization of data related to the user's travel preferences, accommodation choices, and/or activity interests, as well as specific trip details such as destination, duration, etc. The user preference data structure may serve as a repository for this information, ensuring that it is securely stored and readily accessible for future use. The storage of personalized user preferences and trip details may facilitate seamless data sharing between the intelligent travel planning system and the intelligent personal styling system. This data sharing capability may enable the intelligent personal styling system to generate recommendations for packing instructions and/or personalized outfit suggestions that are tailored to the user's unique preferences and the specifics of their upcoming trip. The user preference data structure may also support the intelligent travel planning system in scheduling trips and providing personalized trip recommendations, thereby enhancing the overall travel planning experience for the user.

In some embodiments, the intelligent personal styling system may generate recommended packing instructions for the user. This process may involve using personalized user preferences, trip details, and/or customized size and style preferences of the user. The intelligent personal styling system may access data stored in a user preference data structure, which may include information from previous interactions between the user and/or a personal stylist. The computer system may analyze this data to tailor the recommended packing instructions to the user's needs and preferences. The recommended packing instructions may include a list of suggested items to pack for the trip, which may be displayed as virtual try-ons within the personal stylist's interface. This feature may allow the user to visualize how the recommended item(s) would look together, enhancing the personalization of the packing process. The intelligent personal styling system may also integrate with the user's current wardrobe by accessing a digital representation of the user's existing clothing items. This integration may enable the computer system to suggest items that complement the user's current wardrobe, ensuring a cohesive and stylish travel wardrobe. The recommended packing instructions may be part of a broader interaction between a virtual travel agent and a virtual personal stylist, where data from the travel agent is used to inform the personal stylist's recommendations. This interaction may facilitate seamless coordination between travel planning and personal styling, providing the user with a comprehensive and personalized travel experience.

Moreover, the intelligent personal styling system may generate personalized outfit recommendations for the user. This process may involve performing digital clothing visualization and integrating with the user's current wardrobe. The digital clothing visualization may include generating virtual try-ons of the personalized outfit recommendations, allowing the user to visualize how the suggested outfits may appear when worn by the user. The integration with the user's current wardrobe may involve accessing a digital representation of the user's existing clothing items, which may enable the system to tailor the outfit recommendations based at least in part on the user's available wardrobe. This operation may provide a seamless and personalized styling experience, as it may leverage both the user's preferences and existing wardrobe to offer outfit suggestions that align with the user's style and needs. The intelligent personal styling system may use previously stored data, such as size and style preferences, to enhance the accuracy and relevance of the recommendations. This integration of digital visualization and wardrobe access may facilitate a more interactive and engaging user experience, potentially increasing user satisfaction with the styling suggestions provided.

The intelligent travel planning system may send an automated recommended packing instructions alert to the user. This alert may include both the recommended packing instructions and/or the personalized outfit recommendations. The alert may be sent through various communication channels, such as: email, text message, and/or push notification, to ensure the user receives the information in a timely manner. The intelligent travel planning system may use the stored personalized user preferences and trip details to tailor the recommended packing instructions and/or outfit suggestions to the user's needs and preferences. The notification may serve to inform the user about the items that have been recommended for packing, potentially enhancing the user's travel experience by ensuring they are well-prepared for their trip. The computer system may leverage the interaction between the virtual travel agent and the virtual personal stylist to provide cohesive and integrated recommendations, drawing on data from the user's travel plans and/or their existing wardrobe. These travel techniques may allow for a seamless and personalized approach to travel preparation, aligning with the user's style and travel requirements.

The intelligent travel planning system may provide personalized trip recommendations to the user. This process may be based at least in part on the personalized user preferences and the trip details that have been previously gathered and stored. The intelligent travel planning system, which is sometimes referred to as the ‘AI travel agent,’ may use the stored data to tailor these recommendations to the user's needs and preferences. The process may involve analyzing the user's travel preferences, accommodation preferences, and/or activity preferences, as well as the trip details such as: destination, duration, etc. The AI travel agent may then generate recommended packing instructions that align with these parameters, potentially enhancing the user's travel experience by offering suggestions that are closely aligned with their interests and requirements. This operation may also involve the integration of data from the user preference data structure, helping ensure that the recommendations are informed by up-to-date and comprehensive user information available. The personalized recommended packing instructions may be communicated to the user through various channels, potentially including digital notifications or direct communication from the AI travel agent. This approach may provide the user with curated recommended packing instructions that are designed to improve their trip planning process and ensure a more personalized and satisfying travel experience.

The intelligent personal styling system may receive user input indicating a selection of one or more suggested items from the recommended packing instructions. This interaction may involve the user engaging with the computer system to refine the luggage contents based at least in part on their preferences. The intelligent personal styling system may then update the recommended packing instructions accordingly, potentially altering the list of items to better align with the user's choices. This process may involve the intelligent personal styling system using its capabilities to adjust the recommendations dynamically, ensuring that the user's input is effectively integrated into the final luggage preparation. The computer system may leverage previously stored user preferences and trip details to facilitate this update, ensuring that the recommendations remain personalized and relevant. This interaction may enhance the user's experience by providing a tailored approach to packing, allowing for a more customized travel preparation process. The intelligent personal styling system's ability to adapt to user input may underscore its role in providing a seamless and user-centric service, potentially improving user satisfaction and engagement with the computer system.

The intelligent personal styling system may provide an option for the user to purchase one or more suggested items from the recommended packing instructions. This process may involve the intelligent personal styling system offering a direct buy button or an integrated store link, allowing the user to seamlessly acquire the recommended items. The intelligent personal styling system may use the user's personalized preferences, which have been previously stored and analyzed, to tailor these purchase options. The computer system may integrate with the user's current wardrobe, potentially enhancing the user's travel experience by ensuring that the recommended items align with the user's existing style and needs. The option to purchase may be presented in a user-friendly manner, possibly through a digital interface that allows for easy navigation and selection. This process may be part of a broader interaction between a virtual travel agent and a virtual personal stylist, where data from the user's trip booking and personal styling preferences are used to generate comprehensive and personalized travel and styling recommendations. The intelligent personal styling system may thus play a role in enhancing the user's travel preparation by providing convenient and personalized shopping options.

In the travel techniques, note that the intelligent personal styling system may generate recommended packing instructions (which may include outfit recommendations) by using user preferences and trip details. The computer system may incorporate size and style preferences, which may be derived from previous interactions with the personal stylist agent. The personal stylist agent may suggest items to be included in the luggage, which may be displayed as virtual try-ons within the luggage section. The virtual try-on feature may allow users to visualize the recommended items in conjunction with their existing wardrobe. The intelligent personal styling system may tailor item recommendations by integrating the user's current wardrobe with available items for purchase, potentially offering a buy-now button or store links for convenience. The computer system may also facilitate the addition of individual items or entire outfits to the user's luggage through interactive buttons. The intelligent personal styling system may enhance the user's travel experience by providing personalized styling suggestions that align with the scheduled trip's context.

Note that the computer system may send automated recommended packing instructions to the user. For example, the computer system may notify the user of recommended packing instructions, which may be derived from the recommendations from the intelligent personal styling system. The notification may include recommended packing instructions and/or personalized outfit suggestions, which may be generated based on the user's preferences and trip details. The intelligent travel planning system may receive a trip booking request, schedule the trip, and/or store personalized user preferences and trip details in a user preference data structure. This stored data may be used by the intelligent personal styling system to generate recommended packing instructions. The computer system may then send an alert to the user, informing them of the packing suggestions. This alert may be sent via various communication techniques, such as email, text message, and/or a push notification, ensuring the user is promptly informed. The notification may also include a draft of the luggage contents, ready for packing, which may be accessed through the personal stylist wardrobe section. The computer system may allow for seamless data sharing between the intelligent travel planning system and the intelligent personal styling system, enabling the computer system to effectively communicate the recommendations to the user. This interaction may enhance the user's travel experience by providing tailored packing suggestions that align with their preferences and the specifics of their upcoming trip.

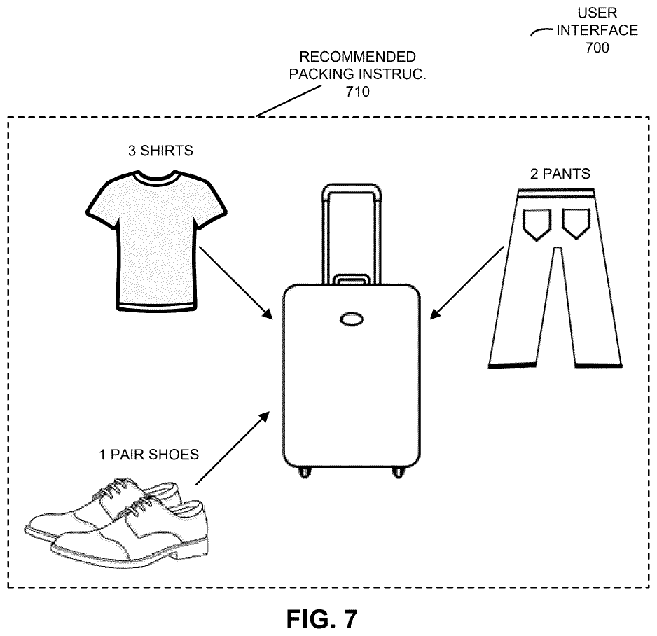

FIG. 7 presents a drawing illustrating an example of a user interface 700. This user interface may display recommended packing instructions 710.

We now describe embodiments of an electronic device. FIG. 8 presents a block diagram illustrating an example of an electronic device 800, such as one of electronic devices 110, optional base station 114, optional access point 118 and/or computer system 120 in FIG. 1. This electronic device includes processing subsystem 810, memory subsystem 812, and networking subsystem 814. Processing subsystem 810 includes one or more devices configured to perform computational operations. For example, processing subsystem 810 can include one or more microprocessors, one or more GPUs, one or more application-specific integrated circuits (ASICs), one or more microcontrollers, one or more programmable-logic devices, and/or one or more digital signal processors (DSPs).

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: one or more program modules or sets of instructions (such as program module 822 or operating system 824), which may be executed by processing subsystem 810. Note that the one or more computer programs may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

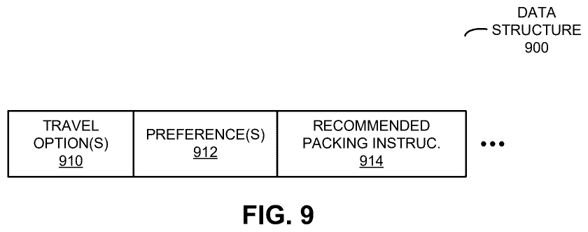

Memory subsystem 812 may store information associated with predefined preferences of one or more recipients. This is shown in FIG. 9, which presents an example of a data structure 900. Notably, data structure 900 may include information specifying: one or more travel options 910, one or more preferences 912 of one or more recipients, and one or more recommended packing instructions 914.

Referring back to FIG. 8, networking subsystem 814 includes one or more devices configured to couple to and communicate on a wired and/or wireless network (i.e., to perform network operations), including: control logic 816, an interface circuit 818, one or more antennas 820 and/or input/output (I/O) port 830. (While FIG. 8 includes one or more antennas 820, in some embodiments electronic device 800 includes one or more nodes 808, e.g., a pad, which can be coupled to one or more antennas 820. Thus, electronic device 800 may or may not include one or more antennas 820.) For example, networking subsystem 814 can include a Bluetooth networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi networking system), an Ethernet networking system, and/or another networking system.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ between the electronic devices does not yet exist. Therefore, electronic device 800 may use the mechanisms in networking subsystem 814 for performing simple wireless communication between the electronic devices, e.g., transmitting advertising or beacon frames and/or scanning for advertising frames transmitted by other electronic devices as described previously.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc. Moreover, electronic device 800 may optionally include a user-interface subsystem 832 for receiving or providing information about a potential gift.

Electronic device 800 can be (or can be included in) any electronic device with at least one network interface. For example, electronic device 800 can be (or can be included in): a desktop computer, a laptop computer, a subnotebook/netbook, a server, a tablet computer, a smartphone, a cellular telephone, a smartwatch, a consumer-electronic device, a portable computing device, an access point, a router, a switch, communication equipment, test equipment, a security camera, an aviation drone, a camera, a wearable appliance, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, display subsystems and/or audio subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments, some or all of a given subsystem or component can be integrated into one or more of the other subsystems or component(s) in electronic device 800. For example, in some embodiments program module 822 is included in operating system 824.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 814, such as a radio. Moreover, the integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals, e.g., determining if the received signal comprises an advertising frame, receiving the input data, etc.)

While communication protocols compatible with Ethernet and Wi-Fi were used as illustrative examples, the described embodiments of the presentation and/or travel techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the presentation and/or travel techniques may be implemented using program module 822, operating system 824 (such as a driver for interface circuit 818) and/or in firmware in interface circuit 818. Alternatively or additionally, at least some of the operations in the presentation and/or travel techniques may be implemented in a physical layer, such as hardware in interface circuit 818.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

In the preceding description, we refer to ‘some embodiments.’ Note that ‘some embodiments’ describes a subset of all of the possible embodiments, but does not always specify the same subset of embodiments.

Moreover, note that the numerical values provided are intended as illustrations of the presentation and/or travel techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a processor configured to execute program instructions; and
memory storing the program instructions, wherein, when the processor executes the program instructions, the computer system performs operations comprising:
receiving, using the interface circuit and from the electronic device, information
specifying a desired travel itinerary;
determining a travel option based at least in part on the information; and
providing, using the interface circuit and addressed to the electronic device, second information specifying the travel option, wherein the travel option is configured for display in a calendar format.

2. The computer system of claim 1, wherein the travel option comprises an associated total cost.

3. The computer system of claim 1, wherein the travel option is based at least in part on a predefined user preference.

4. The computer system of claim 1, wherein the operations comprise:
receiving, using the interface circuit and from the electronic device, an update to the travel itinerary; and
providing, using the interface circuit and addressed to the electronic device, third information specifying a second travel option based at least in part on the update, wherein the second travel option is configured for display in the calendar format.

5. The computer system of claim 4, wherein the update comprises changing one or more of:
a departure time, an arrival time, a number of layovers, a total travel time, one or more non-travel activities during the travel option, or a cost of the travel itinerary.

6. The computer system of claim 4, wherein the update is associated with or corresponds to a change in the travel option displayed in the calendar format.

7. The computer system of claim 4, wherein the operations comprise determining the second travel option based at least in part on the update to the travel itinerary.

8. The computer system of claim 4, wherein the second travel option comprises an updated cost relative to the travel option.

9. The computer system of claim 1, wherein the operations comprise receiving, using the interface circuit and from the electronic device, acceptance of at least a portion of the travel option;
purchasing at least the portion of the travel option on behalf of a traveler; and
providing, using the interface circuit and addressed to the electronic device, a confirmation.

10. The computer system of claim 9, wherein, when the purchase uses financial information corresponding to a financial instrument of a traveler, the operations comprise requesting and then receiving authorization to make the purchase using the financial information.

11. The computer system of claim 1, wherein the travel option is determined using a pretrained neural network.

12. The computer system of claim 11, wherein the pretrained neural network comprises a large language model (LLM).

13. The computer system of claim 1, wherein the travel option comprises: flight information, a restaurant, a lodging or accommodation, or an event.

14. A non-transitory computer-readable storage medium for use in conjunction with a computer system, the computer-readable storage medium storing program instructions that, when executed by the computer system, cause the computer system to perform operations comprising:
receiving, from an electronic device, information specifying a desired travel itinerary;
determining a travel option based at least in part on the information; and
providing, using the interface circuit and addressed to the electronic device, second information specifying the travel option, wherein the travel option is configured for display in a calendar format.

15. The non-transitory computer-readable storage medium of claim 14, wherein the operations comprise:
receiving, from the electronic device, an update to the travel itinerary; and
providing, addressed to the electronic device, third information specifying a second travel option based at least in part on the update, wherein the second travel option is configured for display in the calendar format.

16. The non-transitory computer-readable storage medium of claim 15, wherein the update is associated with or corresponds to a change in the travel option displayed in the calendar format.

17. A method for intuitively and interactively presenting a travel option, comprising:
by a computer system:
receiving, from an electronic device, information specifying a desired travel itinerary;
determining the travel option based at least in part on the information; and
providing, using the interface circuit and addressed to the electronic device, second information specifying the travel option, wherein the travel option is configured for display in a calendar format.

18. The method of claim 17, wherein the method comprises:
receiving, from the electronic device, an update to the travel itinerary; and
providing, addressed to the electronic device, third information specifying a second travel option based at least in part on the update, wherein the second travel option is configured for display in the calendar format.

19. The method of claim 18, wherein the update is associated with or corresponds to a change in the travel option displayed in the calendar format.

20. The method of claim 18, wherein the update comprises changing one or more of: a departure time, an arrival time, a number of layovers, a total travel time, one or more non-travel activities during the travel option, or a cost of the travel itinerary.
